(19) United States
(12) Patent Application Publication
(10) Pub. No.: US 2025/0326569 A1
(43) Pub. Date: Oct. 23, 2025

(54) GRAVIMETRIC METERING UNIT FOR FLOWABLE BULK MATERIAL

(71) Applicant: K-TRON TECHNOLOGIES, INC., Sewell, NJ (US)

(72) Inventors: Men BERNEGGER, Zurich (CH); Rolf LEHMANN, Ammerswil (CH)

(73) Assignee: K-TRON TECHNOLOGIES, INC., Sewell, NJ (US)

(21) Appl. No.: 18/714,749

(22) PCT Filed: Nov. 23, 2022
(86) PCT No.: PCT/IB2022/061352

§ 371 Date: Jun. 30, 2025

(30) Foreign Application Priority Data
Dec. 2, 2021 (CH) CH070640/2021

(51) Int. Cl. B65D 88/68; B65G 33/26; B65G 65/46

(52) U.S. Cl. CPC B65D 88/68; B65G 33/26; B65G 65/46

(57) ABSTRACT

The disclosure relates to a method for metering bulk material by means of a metering device which has a conveyor container for bulk material to be metered and an elongated conveyor, which extends through the conveyor container, for the bulk material, which the conveyor transports out of the conveyor container to a dispensing line, wherein the bulk material located in the conveyor container is stirred by a stirring mechanism during the metering process and thus continuously forming bridges of bulk material are again removed, wherein the area at least lateral to the conveyor in the conveyor container is stirred, or the active area of the stirring mechanism of a metering device covers an area in the conveyor container lateral to the conveyor.

### CROSS-REFERENCED TO RELATED APPLICATION

This application is a 35 USC 371 national phase entry of PCT Application No. PCT/IB2022/061352 filed on Nov. 23, 2022, which claims priority to CH070640/2021 filed on Dec. 2, 2021, the entire contents of both are hereby incorporated by reference.

### TECHNICAL FIELD

The present disclosure relates to a method for metering bulk material by means of a metering device, in embodiments a method for gravimetric metering, and to a metering device, which is designed as a gravimetric metering unit in embodiments.

Metering devices, but also gravimetric metering devices, known as loss-in-weight-feeders, have been known for decades and are widely used in many branches of industry for all kinds of flowable or pourable materials, i.e., bulk materials, as long as they can be conveyed by a gravimetric metering device at all. In this case, the bulk materials are metered into a container, from this into a base unit located below it, and dispensed from the metering device, by a conveyor located in the base unit, into a dispensing channel. The metering device is located on a scale, so the weight registered by the scale is the gross weight, i.e., the known and constant weight of the metering device components (tare) plus the variable weight of the bulk material currently present in the container and in the base unit (net weight).

In this manner, the scale continuously registers the weight loss of the entire metering device during operation, and thus, due to the constant weight of the metering device, the weight loss of the bulk material present in the metering device, so that a controller of the metering device can determine the actual mass flow of the bulk material dispensed from the weight loss and, in comparison with a predetermined target mass flow, control the dispensing conveyor accordingly in order to minimize the difference between the actual and target mass flows.

Very precise control of the output mass flow may be necessary, such as in the area of pharmaceuticals or when color pigments are to be added in industrial manufacturing. In addition, the target mass flow can be small, e.g., for the color pigments mentioned and in the production of medicines (e.g., less than 1 kilogram per hour), or large, e.g., in the field of plastics production and in mining (e.g., more than 1 t per hour up to, for example, 3.5 t per hour or more), wherein highly precise metering possibly can also be necessary for such conveying capacities. Furthermore, different batches can be run one after the other, wherein, in addition to regular maintenance, additional intensive cleaning may then be necessary, depending upon the bulk material.

### SUMMARY

As scales, all types of precise scales are often used which have a resolution over

their weighing range of 1:100,000 and more, including those having vibrating wire sensors, such as those known for example by the designations SFT-III, SFT-II-M, and SFT-II-L from Coperion K-Tron. Today, these scales have a resolution of up to 1:4,000,000, so that precision metering can be carried out without any problems, even in the case of a container capacity of several hundred kilos and a delivery rate of several tons per hour. If a resolution of, for example, 1:1 000 000 is used, then, in the case of a weighing capacity of 100 kg, the weight can still be recorded to an accuracy of 1/10 g and then used for metering. It is to be expected that the resolution of the scales will be further improved in the near future.

Frequently, non-vertical, i.e., horizontal or inclined, conveyors are implemented, as the fluid-dynamic behavior of the bulk material can be controlled somewhat better in this manner, as gravity does not act in the conveying direction, inter alia, in the case of horizontal conveyors, and thus does not influence the flow of the bulk material. Longer screw conveyors, for example, are well suited as horizontal conveyors, as the actual flow rate can be varied quite easily and without distortion via their rotational speed, in the case of a suitable drive, and the distance from the mass flow from the funnel to a collecting container located outside the metering unit can be bridged well, without any disadvantages in the actual mass flow itself. Often, such conveyors in a metering device of the type mentioned are clamped into a holder on an end shaft, the wherein holder supports the conveyor in a precisely aligned manner in its conveyor tube, which thus forms a conveyor channel. Likewise, for example, belt conveyors made from a rotating conveyor belt can also be used, where the feed rate can be varied just as easily and without delay via the feed speed, as is the case with a screw-conveyor.

The uniform filling of the conveyor, even in the case of a screw-conveyor or a belt conveyor, is, depending upon the bulk material to be metered, simple, challenging, or highly problematic, even to the point of metering being impossible. The bulk material stored in the periodically refilled funnel is intended to flow continuously downwards from the funnel, often into a transfer funnel, and then into a conveyor container in which the conveyor is located, which is loaded with the incoming bulk material and transports it, e.g., controlled gravimetrically, into a dispensing line.

In this case, not only the shape of the individual bulk material particles determines the flow behavior, but also its surface texture and properties, wherein the latter in turn are able to be changed by the ambient temperature and humidity, which in turn may sometimes have a significant effect on the flow behavior of the bulk material. In addition to the flow behavior itself, the bridging effect is also important for metering. Bridging occurs when bulk material particles that have settled in the funnel, transition funnel, or conveyor container solidify, form deposits, and the solidified regions or deposits grow to the point where the intended flow cross-section extending from the funnel to the conveyor narrows somewhere along the flow path-in the worst case to such an extent that bulk material that is still flowing can no longer flow in sufficient quantities due to the narrowing. Like the flow properties themselves, the tendency to bridging varies from bulk material to bulk material, and can also depend upon the ambient conditions.

All in all, bulk materials can be divided into free-flowing, moderately flowing, heavily flowing, and non-meterable, wherein it is possible for this classification to depend not only upon the material itself and the specific metering device used, but also upon the ambient conditions (e.g., temperature, humidity, etc.). Free-flowing bulk materials can also be metered gravimetrically without mechanical assistance. Moderately flowing or heavily flowing materials are metered using gravimetric metering devices, for example, which have a stirring mechanism that sweeps over the solidified regions of the bulk material and thus breaks down the bridges that have been built up or prevents them from forming in the early stages. For moderately flowing bulk materials, horizontal stirring mechanisms arranged in the conveyor container above the conveyor are known, and, for heavily flowing bulk materials, vertical stirring mechanisms are additionally arranged in the funnel. Furthermore, vibrators acting upon the funnel instead of vertical stirrers have become known, which vibrators prevent bridge formation or destroy bridges that have formed, in the funnel, not by mechanical stirring, but by vibrations. In the present description, stirring refers to any mechanical displacement of bulk material located in the metering device by an actuator moving through the bulk material, and stirring mechanism refers to an arrangement having such an actuator.

Therefore, when there is a specific metering requirement, the laboratory of the manufacturer of the gravimetric metering unit usually records the behavior of the bulk material to be metered under the intended production conditions-where necessary, also by means of tests-and then a suitable horizontal or vertical stirring mechanism, possibly also a vibrator, is provided for the metering device.

The disadvantage of conventional stirring mechanisms is the manufacturing effort, both in terms of the stirring mechanism itself and its drive, since a stirring mechanism, in contrast to a screw-conveyor, for example, has to be operated at a comparatively low speed and high torque, which, in addition to the higher motor power, also requires an additional gear stage for the joint drive of the stirring mechanism and the conveyor.

Accordingly, it is the object of embodiments to provide a simplified metering device for moderately flowing and heavily flowing bulk materials, which is also suitable for gravimetric operation.

This object is achieved by embodiments.

Because at least the area to the side of the conveyor is stirred, solidifying deposits are prevented on the side walls of the conveyor container running alongside the conveyor, which deposits in turn can serve as a base for subsequent deposits growing upwards into the funnel beyond the transition funnel, widening and then forming bridges that reduce the flow cross-section. If the side walls of the conveyor container running alongside the conveyor remain free of deposits, the conveyor container can be made wide in the region of the conveyor itself, which in turn results in a large flow cross-section for the bulk material and leads to a good and uniform fill level of the conveyor, in particular of a screw-conveyor. At the same time, the flow cross-section from above, out of the funnel into the conveyor container, is also wide and thus less sensitive to bridge formation in the funnel, since bridges growing over a larger cross-section are more likely to collapse on their own.

As mentioned above, since the active area of the stirring mechanism occupies an area in the conveyor container to the side of the conveyor, the necessary flow cross-section to the conveyor is kept open, wherein it is possible in addition for the stirring mechanism to be driven by the conveyor itself, so that its construction is particularly simple, and, for example, an additional gear stage is not required.

Embodiments have the features of the dependent claims.

### BRIEF DESCRIPTION OF THE DRAWINGS

Exemplary embodiments are described in more detail below with reference to figures, in which the following are shown schematically and by way of example:

Embodiments are described in more detail below with reference to the figures.

In the figures:

FIG. 1a is a schematic view of a gravimetric metering unit having a metering device according to the prior art,

FIG. 1b is a schematic cross-section through the metering unit of FIG. 1a in view AA

FIG. 2a is a 3-D view of a metering device according to embodiments, into the transition funnel,

FIG. 2b is a cross-sectional view through the metering device of FIG. 2a,

FIG. 3 is a 3-D view of a stirring mechanism according to embodiments, and

FIG. 4 is a 3-D view of a modified stirring mechanism according to embodiments.

### DETAILED DESCRIPTION

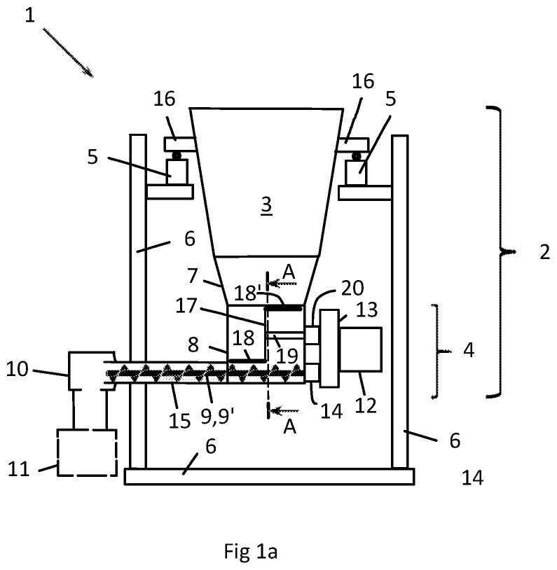

FIG. 1a is a schematic view of a gravimetric metering unit 1 of the prior art for moderately flowing or even heavily flowing bulk materials of the type mentioned above. In the metering unit 1, a metering device 2 having a funnel 3 and a base unit 4 is suspended above scales 5 in a frame 6.

During operation, the funnel 3 is filled with bulk material, which falls here via a transition funnel 7 (which can also be omitted) of the base unit 4 into a conveyor container 8, through which, in the embodiment shown, a conveyor designed as parallel, side-by-side screw-conveyors 9, 9′ protrudes, which conveys the bulk material from right to left into a dispensing line 10, via which the bulk material reaches a further conveyor portion 11 indicated by dashed lines for further processing. In the figure, the screw-conveyor 9 conceals the parallel screw-conveyor 9′. A cross-section through the conveyor container 8 and the screw-conveyors 9, 9′ is shown in FIG. 1b. The funnel 3 is refilled before it is empty.

The base unit 4 comprises, in addition to the conveyor container 8, a drive motor 12 having a gear 13, and the screw-conveyors 9, 9′ driven by the gear 13, which in turn are mounted on the mandrels of a holder 14 and extend after the conveyor container 8 through a conveyor channel 15, which also belongs to the base unit, to the dispensing line 10.

The metering device 2 rests via supports 16 on the scales 5, which register the weight of the metering device 2 and the weight of the bulk material in the funnel 3 (and in the base unit 4). If, during gravimetric operation of the metering unit 2, bulk material is discharged into the further conveyor portion 11 by the rotation of the screw-conveyors 9, 9′, the weight of the metering device 2 is reduced accordingly, which is registered by the scales 5 and in turn evaluated by a control system (not shown in order to reduce the complexity of the figure). The weight reduction corresponds to the actual mass flow of bulk material dispensed, which must be adjusted to the target mass flow. For this purpose, the control system continuously corrects the speed of the screw-conveyors 9, 9′ via the drive motor 12 in accordance with a control algorithm that is generally known to a person skilled in the art.

During operation, moderately flowing or heavily flowing bulk material is filled into the container 3, which material falls out of this via the transition funnel 7 into the conveyor container 8 and is conveyed there to the left into the dispensing line 10 by the screw-conveyors 9, 9′ running in the conveying pipe 15.

At least in the conveyor container 8, there is now a stirring mechanism 17 which, in the embodiment shown, has two stirring blades 18 and 18′ rotating about a shaft 19, acts above the screw-conveyors 9, 9′, and there removes the deposits of bulk material on the side walls of the conveyor container 8 and thus keeps open the flow cross-section in the flow path of the bulk material from the transition funnel 7 through the conveyor container 8 to the screw-conveyors 9, 9′, with the result that the screw-conveyors 9, 9′ are filled evenly. The stirring mechanism 17 is mounted by a shaft 19 in the holder 20 and is driven by a separate stage of the gear 13.

FIG. 1b is a schematic cross-section through the conveyor container 8 of the metering device 2 of the metering unit 1 in FIG. 1a, along the line AA. It can be seen that the screw-conveyors 9, 9′ are located in a narrow channel 24 below the stirring mechanism 17, so that the stirring blades 18, 18′ move over the channel 24 during operation and thus keep the access to the channel free. Two screw-conveyors 9, 9′ are provided, on the one hand, to keep the channel 24 wide enough so that it does not noticeably begin to clog up during slow stirring (depending upon the bulk material), and, on the other hand, because filling can take place only from above, enough bulk material can enter the channel 24 at any time, and is then also conveyed. The intermeshing screw-conveyors 9, 9′ prevent deposits between the screw-conveyors 9, 9′.

Furthermore, the conveyor container 8 is circular in a lower region 21 and is designed having parallel walls in an upper region 22, so that, in the lower region 21, the active area 23 of the stirring mechanism 17, shown in dashed lines, is located close to the walls of the conveyor container 8, where otherwise deposits could accumulate (usually from below) and build up bridges. As a result, the bulk material is fed directly into the screw-conveyors 9, 9′, which ensures that non-free-flowing bulk materials are reliably metered.

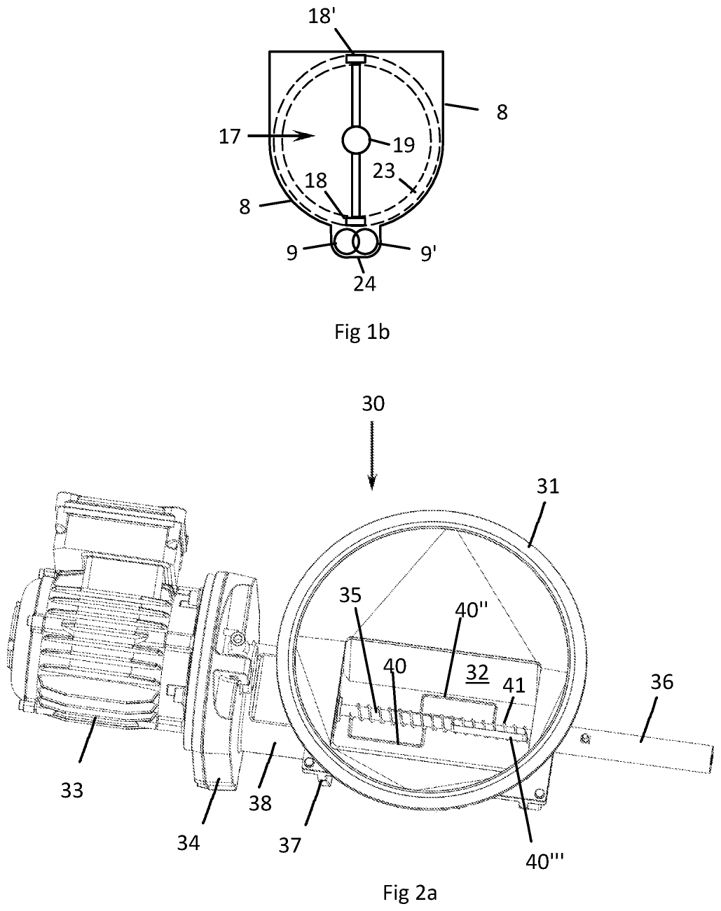

FIG. 2a is a 3-D view of the base unit 30 of a metering device according to embodiments, which has a transition funnel 31, a conveyor container 32, a motor 33, a gear 34, a single screw-conveyor 35, and a tubular conveyor channel 36 from which metered bulk material is dispensed. The conveyor container 32 is fixed via a flange 37 to the gear 34 or to a holder 38 arranged on the latter (analogous to the holder 14 of FIG. 1a). The screw-conveyor 35 located in the middle of the conveyor container 32 has a number of stirring elements, designed as stirring blades 40 to 40″ in the embodiment shown, wherein the stirring blade 40′ is covered by the screw-conveyor 35 in the figure. In the embodiment shown, the stirring blades 40 to 40″ are arranged on the helix 41 of the screw-conveyor 35-in embodiments welded thereto. As mentioned above, a belt conveyor or other suitable conveyor could be provided instead of the screw-conveyor 35. Likewise, the design of the stirring elements in the specific case is not limited to the stirring blades 40 to 40″′ shown.

FIG. 2b is a view, in the direction of the gear 34, of a section through the base unit 30 of FIG. 2a transverse to the screw-conveyor 35. This is located in the volume of the conveyor container 32, which has a lower region 42 which is curved in a circular arc and adapted to the movement of the stirring blades 40 to 40″, and an upper region 43 which is funnel-shaped and opens towards the top. The stirring mechanism 17, in the embodiment shown formed by the screw-conveyor 35 and the stirring blades 40 to 40″, has an active area 44 in which the stirring mechanism 17 stirs, which is indicated by the dot-dashed line 45 and which, among other things, covers the area indicated between the two dashed lines 46, 46′ to the side of the conveyor, which, in the embodiment shown, has a screw-conveyor 35.

It has now been shown that at least moderately flowing bulk materials, which in the prior art had to be metered, for example, at least using a complex horizontal stirrer of the type of a stirrer according to FIGS. 1a and 1b, can surprisingly also be metered well if the area to the side of the conveyor is stirred, or if the active area of the conveyor covers an area to the side of the conveyor. As mentioned above, this appears to effectively prevent a major source of bridge-forming deposits. The applicant has found that an additional conveyor chamber formed by the conveyor container 32, which opens upwards in a funnel shape, is nevertheless advantageous and further supports the beneficial effect of lateral stirring, since the opening cross-section between the conveyor container 32 and the transition funnel 31 (or, if this is not provided, the funnel 3; see FIG. 1a) is then particularly large, in contrast to the conveyor container 8 of FIG. 1b. A large opening cross-section obviously forms such a large flow cross-section for the bulk material that it is more difficult for bridges to narrow or close it. In addition, with a larger lower opening cross-section, the walls of the transition funnel 31 itself can be made steeper, since the transition funnel 31 often has a standard upper cross-section for a selection of funnels available for selection. Steeper walls create an additional obstacle for deposits. Thus, in the embodiment shown in FIG. 2b, the conveyor container 32 and the transition funnel 31 both have (at least in part) the same steep angle, so that, even for difficult bulk materials, there are worse conditions for deposits. In the variety of heavily flowing bulk materials (and the ambient conditions), an additional vibrator must therefore be provided less often than could be expected when using the stirring mechanism according to embodiments or is the case with an embodiment that is normally dimensioned with a view to the desired conveying capacity according to FIGS. 1a and 1b.

For the reasons mentioned above, as can be seen in FIG. 2, in embodiments, the conveyor container 32 has, at least over a length portion in which the area lateral to the conveyor 35 is stirred, side walls which are inclined in cross-section and open in a funnel shape towards the top. Furthermore, in embodiments a funnel 31 or a transition funnel is provided on the conveyor container 32, the side walls of which funnel have, over a length portion in which the area lateral to the conveyor is stirred, inclined side walls in cross-section, opening in a funnel shape towards the top, which are aligned with the funnel-shaped side walls of the conveyor container (32).

The result—for embodiments—is a metering device for bulk material having a conveyor container through which a conveyor extends, which leads to a dispensing line, and having a stirring mechanism for removing bridges formed from bulk material during operation, wherein the active area of the stirring mechanism covers an area in the conveyor container to the side of the conveyor. Furthermore, for embodiments, a method for metering bulk material by means of a metering device is provided which has a conveyor container for bulk material to be metered and an elongated conveyor, extending through the conveyor container, for the bulk material, which the conveyor transports out of the conveyor container to a dispensing line, wherein the bulk material in the conveyor container is stirred by a stirring mechanism during metering and thus continuously forming bridges of bulk material are again removed, and wherein the area in the conveyor container at least lateral to the conveyor is stirred. Furthermore, in the case of heavily flowing bulk materials, a person skilled in the art can also, depending upon the bulk material and the ambient conditions, further provide for the arrangement of a vibrator on the funnel 31 or, e.g., in the case of a large-dimensioned transition funnel, on the latter, which ensures that deposits that have a negative effect on the flow cross-section of the bulk material are already prevented at the top of the funnel or at the top of the transition funnel.

According to the embodiment shown in FIG. 2b, the active area of the stirrer covers an area in the conveyor container below the conveyor, i.e., also below the dashed line 45, or the area in the conveyor container below the conveyor is further stirred. Furthermore, according to FIG. 2a, in embodiments, the active area of the stirring mechanism (in FIG. 2a, the screw-conveyor 35 having the stirring blades 40 to 40″) cover an area in the conveyor container over a length of the conveyor portion extending in the conveyor container, in embodiments over the entire length of the conveyor portion (in FIG. 2a, the length of the portion of the screw-conveyor 35 that lies in the conveyor container 32). Then, in the conveyor container 32, the area around the conveyor over a length portion thereof is stirred, which, however, in the specific case, depending upon the bulk material and the ambient conditions, can also be dimensioned by a person skilled in the art to be shorter. Furthermore, according to the embodiment shown in FIGS. 2a and 2b, it is advantageous to use a conveyor designed as a screw-conveyor 35 and also to provide a horizontally aligned conveyor. In the case of horizontal alignment, gravity has no effect on the conveying effect and therefore on the metering. A metering device having a base unit according to embodiments, for example in the embodiment according to FIGS. 2a and 2b, has a simple structure and a precise conveying behavior, uninterrupted by deposits or bridges in the bulk material, even for moderately flowing or heavily flowing bulk materials, and is therefore, in embodiments, used in a metering unit for gravimetric metering.

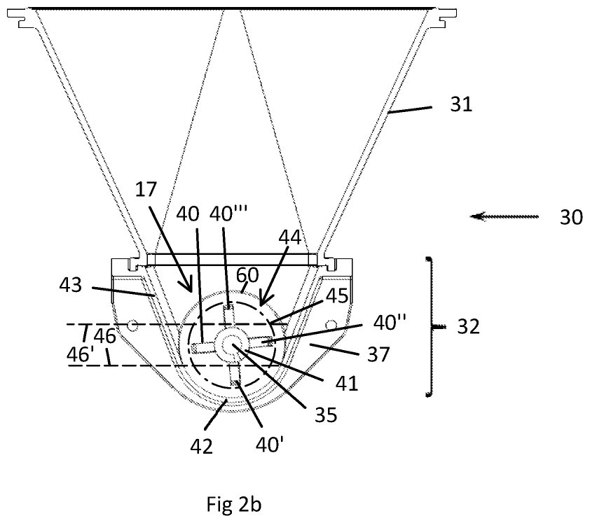

FIG. 3 is a 3-D view of the screw-conveyor 35 according to FIGS. 2a and 2b having the stirring blades 40 to 40″. Also visible are a shaft 47, hidden in FIG. 2a by its holder 38, and the helix 41. The stirring elements designed as stirring blades 40 to 40″ (which, together with the screw-conveyor 38 supporting and driving them, form the stirring mechanism 17 according to FIGS. 2a and 2b) have portions 48 to 48″ parallel to the screw-conveyor 38, which can thus sweep along the walls of the conveyor container 32 over their entire length. It follows that the stirring mechanism 17, in embodiments, has (at least) one stirring element which has at least one portion 48 to 48″ which extends parallel to the conveyor (here, the screw 35). Furthermore, in embodiments, the stirring mechanism 17 has stirring elements which are arranged on the screw-conveyor 35—here, the helix 41. By its very nature, the helix has a pitch such that a portion of a stirring element, and thus of the stirring mechanism, connected to the helix, extends away from the axis of the screw-conveyor and is, in embodiments, inclined to the direction of its rotational speed such that bulk material caught by it during operation is pushed in the conveying direction. This has the advantage that the stirred bulk material is also pressed lengthwise in the conveying direction by the stirring movement and thus mixes better with subsequent bulk material-for example, even if stirring is carried out with a stirring movement that is perpendicular to the conveying direction.

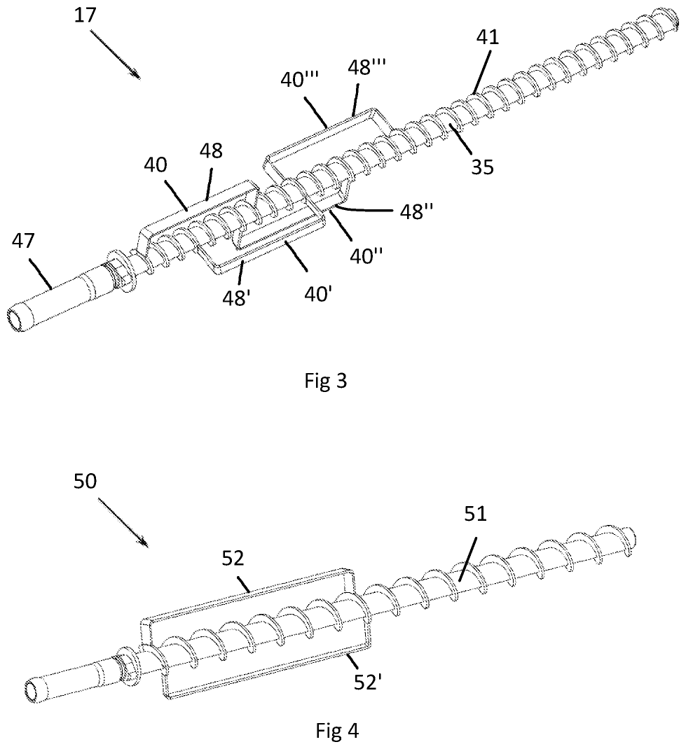

FIG. 4 is a 3-D view of another embodiment of an stirring mechanism 50, having a modified screw-conveyor 51 and differently designed stirring elements 52, 52′.

A stirring mechanism, not shown in the figures, can also be designed without the conveyor, e.g., in that the gear cover plate 60 visible in FIG. 2b on the rear wall of the conveyor container 32 is designed to be rotating and has a number of stirring elements arranged, for example, on its periphery and extending into the area of the conveyor container 32, which elements can be designed in the shape of a rod and, in embodiments, extend parallel to the screw-conveyor. Furthermore, paddles connected to the screw-conveyor and protruding from it can also be provided as stirring elements. Finally, another embodiment of the stirring elements, not shown in the figures, has a large helix which winds itself spirally at a distance coaxially around the screw-conveyor or around a belt conveyor, and thus covers the walls of the conveyor container during operation.

FIGS. 3 and 4 show, in summary, a design of a screw-conveyor for a metering device, having at least one stirring element for bulk material arranged on it. In embodiments, the stirring element is arranged on the screw helix and has at least one portion which extends parallel to its longitudinal axis or which is itself designed as a helix.

1. A method for metering bulk material by means of a metering device which has a conveyor container for bulk material to be metered and an elongated conveyor, which extends through the conveyor container, for the bulk material, which the conveyor transports out of the conveyor container to a dispensing line, wherein the bulk material located in the conveyor container is stirred by a stirring mechanism during the metering process and thus continuously forming bridges of bulk material are again removed, wherein, in the conveyor container, the area at least lateral to the conveyor is stirred.

2. The method according to claim 1, wherein, in the conveyor container, the area below the conveyor is further stirred.

3. The method according to claim 1, wherein, in the conveyor container, the area around the conveyor over a length portion of the conveyor is stirred.

4. The method according to claim 1, wherein stirring is carried out with a stirring movement which is perpendicular to the conveying direction.

5. The method according to claim 1, wherein the bulk material is pressed in the conveying direction via the stirring movement.

6. The method according to claim 1, wherein a horizontally oriented conveyor is used.

7. The method according to claim 1, wherein a screw-conveyor is used.

8. The method according to claim 1, wherein the metering device is used for gravimetric metering in a metering unit.

9. A metering device for bulk material having a conveyor container through which a conveyor extends, which leads to a dispensing line, and having a stirring mechanism for removing bridges formed from bulk material during operation, wherein the active area of the stirring mechanism covers an area in the conveyor container lateral to the conveyor.

10. The metering device according to claim 9, wherein the active area of the stirring mechanism covers an area in the conveyor container below the conveyor.

11. The metering device according to claim 9, wherein the active area of the stirring mechanism covers an area in the conveyor container over a length of the conveyor portion extending in the conveyor container.

12. The metering device according to claim 9, wherein the stirring mechanism has a stirring element having at least one portion extending parallel to the conveyor.

13. The metering device according to claim 9, wherein the conveyor has a screw-conveyor.

14. The metering device according to claim 13, wherein the stirring mechanism has stirring elements which are arranged on the screw-conveyor.

15. The metering device according to claim 13, wherein the stirring mechanism has at least one portion which extends away from the axis of the screw-conveyor.

16. The metering device according to claim 9, wherein the conveyor container has, at least over a length portion in which the area lateral to the conveyor is stirred, side walls which are inclined in cross-section and open in a funnel shape towards the top.

17. The metering device according to claim 16, wherein a funnel or a transition funnel is provided on the conveyor container, the side walls of which have, over a length portion in which the area lateral to the conveyor is stirred, side walls which are inclined in cross-section, open upwards in a funnel shape, and which are aligned with the funnel-shaped side walls of the conveyor container.

18. The metering device according to claim 9, wherein the conveyor container has a length and, over a length portion in which the area lateral to the conveyor is stirred, is designed to be circular-arc-shaped in cross-section thereto in a lower region, and to open upwards in a funnel-shaped manner in an upper region adjoining the lower region.

19. The metering device according to claim 9, having a funnel, wherein a vibrator is arranged on the funnel.

20. A metering-unit including a metering device according to claim 9.

21. A screw-conveyor for a metering device, including at least one stirring element for bulk material arranged on it.

22. The screw-conveyor according to claim 21, wherein the stirring clement is arranged on the screw helix and has at least one portion which extends parallel to its longitudinal axis.

23. Screw-conveyor The screw-conveyor according to claim 21, wherein the stirring element has at least one portion which has a pitch in the conveying direction, such that the stirring element conveys the bulk material in the conveying direction.
